(19) United States
(12) Patent Application Publication
(10) Pub. No.: US 2010/0117893 A1
(43) Pub. Date: May 13, 2010

(54) Reflector Antenna for the Reception and Transmission of Signals From and to Satellites

(75) Inventors: Achim Dreher, Worthsee (DE); Christoph Gunther, Wessling (DE)

Correspondence Address: JANSSON SHUPE & MUNGER LTD., 245 MAIN STREET, RACINE, WI, 53403, US

(73) Assignee: DLR DEUTSCHES ZENTRUM FUR LUFT- UND RAUMFAHRT E.V., Koln (DE)

(21) Appl. No.: 12/612,042

(22) Filed: Nov. 4, 2009

(30) Foreign Application Priority Data
Nov. 13, 2008 (DE) 102008057088.5-55

(51) Int. Cl. H01Q 3/00; H04B 7/185

(52) U.S. Cl. 342/352; 342/368; 342/373; 342/374

(57) ABSTRACT

A reflector antenna, in particular for the reception and/or transmission of signals from and/or to satellites. The reflector antenna according to the invention comprises a reflector arrangement for focusing antenna radiation in a focal plane together with an antenna array arranged in the focal plane, or in the vicinity of the focal plane, with a plurality of antenna elements. A control device is provided with a beamforming means. Through the control device, sub-arrays, comprising one or a plurality of antenna elements of the antenna array for the reception and/or transmission of antenna radiation, can be activated and deactivated. In the operation of the reflector antenna, a radiation lobe pattern is formed by means of the beamforming means for the reception and/or transmission of antenna radiation for a particular activated sub-array.

### CROSS REFERENCE TO RELATED APPLICATION

This application claims priority based on German patent application DE 10 2008 057 088.5-55, filed Nov. 13, 2008.

### BACKGROUND

Reflector antennas are used, for example, in satellite navigation for purposes of communication between mobile terrestrial terminals, or terminals installed on so-called LEO-satellites, and geostationary satellites (also designated as GEO-satellites). LEO-satellites are satellites with a low earth orbit, located approx. 200 to 1500 km above the earth's surface. Reflector antennae focus the antenna radiation in a focal plane and in this manner achieve a high gain, which because of the high level of free space attenuation is also required in satellite communication. The reflector antennae known from the prior art have a prescribed radiation lobe pattern, which can be aligned in various directions by mechanical control of the reflector antenna.

Furthermore, antenna arrays directly radiating or receiving radiation with a plurality of antenna elements are of known art. Phased array antennas exist, in which the phase of the analogue antenna signal is modified with an electronic controller and as a result beam deflection is effected. Moreover, antenna arrays with digital beamforming are of known art, by which the radiation lobe pattern is formed purely by means of digital signal processing. Directly radiating antenna arrays cannot be implemented technologically for transmission over large distances with high data rates. This is because antenna arrays with several tens of thousands of antenna elements would have to be used for this purpose. In the case of phased arrays this would entail the same number of corresponding phase shifters, or in the case of antenna arrays with digital beamforming the same number of corresponding front-ends with A/D converters. With the current data processing speeds of processors, arrays of this kind cannot be manufactured.

The paper entitled “Adaptive Beamforming With a Multiple Beam Antenna” by Jason Duggan and Peter McLane (J. Duggan and P. McLane, “Adaptive beamforming with a multiple beam antenna”, IEEE Int. Conf. Communications, Atlanta, Ga., USA, June 1998, Vol. 1, Pages 395-401) describes adaptive beamforming for a reflector antenna with a feed by means of an antenna array with fixed interconnections. With the beamforming shown in this document radiation lobe patterns are generated with null points for purposes of interference suppression; no beam deflection over wider ranges of angles is enabled, however.

The object of the invention is to create a reflector antenna, which combines data transmission over large distances with electronic beam deflection.

This object is achieved by means of the reflector antenna according to claims of the invention. Preferred embodiments of the invention are defined by these claims.

The reflector antenna according to the invention comprises a reflector arrangement for the purposes of focusing antenna radiation in a focal plane as well as an antenna array arranged in the focal plane, or in the vicinity of the focal plane, with a plurality of antenna elements. The term “vicinity of the focal plane” is to be understood as an arrangement of the antenna array at a distance from the focal plane that deviates by a maximum of 10% from the corresponding focal length of the focal plane. Tolerances should be taken into account here, as well as the fact that an arrangement of the antenna array displaced relative to the focal plane within certain limits also enables a reasonable feed of the reflector antenna. In the case of an arrangement of the antenna array in the vicinity of the focal plane, the antenna array is preferably arranged in a plane running parallel to the focal plane. A planar antenna array is preferably used as the antenna array.

In order to enable beam deflection over a larger angle range, the reflector antenna comprises a control device with a beamforming means. By means of the control device, sub-arrays comprising one or a plurality of antenna elements of the antenna array can be activated and deactivated for the reception and/or transmission of antenna radiation. In operation of the reflector antenna for a respective activated sub-array, a radiation lobe pattern is formed by means of the beamforming means for the reception and/or transmission of antenna radiation. Here the term “radiation lobe pattern” denotes the spatial region formed for the sub-array, in which spatial region antenna radiation is transmitted and/or received by means of the reflector antenna.

The reflector antenna according to the invention is distinguished in that various sub-arrays can be activated by means of a control device and the radiation lobe pattern formed for an activated sub-array can be used for the reception and/or transmission of antenna radiation. In this manner a spatial displacement of the radiation lobe patterns of the sub-arrays is enabled, and thus beam deflection. Conventional mechanical reflector antennae control for purposes of beam deflection can be dispensed with in the present invention. Here the reflector antenna according to the invention combines the advantages of the high gain of a reflector antenna with flexible beamforming based on suitable activation and deactivation of sub-arrays.

In particular the reflector antenna according to the invention can be deployed for the reception and/or transmission of signals from and/or to satellites. Antennae with high gain and flexibility are required in satellite communication, for example, to transmit information at high data rates between mobile users and geostationary satellites, or between LEO and GEO satellites, or to generate spot beams in communication with high-altitude platforms or new systems for purposes of satellite navigation.

In a preferred embodiment of the reflector antenna according to the invention, at one point in time, an individual sub-array or a plurality of sub-arrays can be activated by means of the control device simultaneously. In this manner very flexible beamforming is achieved.

In another preferred embodiment, the sub-arrays overlap at least partially with one another, as a result of which continuous beam deflection is ensured. Nevertheless, it is also possible that the sub-arrays are at least partially disjoint.

In a further preferred embodiment of the reflector antenna according to the invention, one or a plurality of groups of sub-arrays is provided, wherein in the operation of the reflector antenna each group is controlled by means of the control device through activation and deactivation of the sub-arrays of the group to track a separate signal. In this manner a plurality of various signals can be continuously received or transmitted in parallel in a single reflector antenna. A separate signal, tracked by one group of sub-arrays, is thereby preferably a signal from and/or to an object moving relative to the reflector antenna, wherein the object is preferably a satellite. In this manner particularly the tracking of the signals of a plurality of satellites, in particular of LEO satellites, is ensured by the reflector antenna. Here the reflector antenna is, for example, part of a GEO data relay on a GEO satellite.

In yet another preferred embodiment, the control device of the reflector antenna according to the invention comprises a switching matrix arrangement with one or a plurality of switching matrices, by which arrangement the antenna elements of the respective sub-arrays can be interconnected with the beamforming means for purposes of activation and deactivation. In this manner, an embodiment of an activation or deactivation of sub-arrays is created that can be implemented simply. Here the switching matrix arrangement is preferably implemented based on MEMS technology (MEMS=Micro-Electromechanical System), with which high-precision miniaturized components can be created. MEMS technology is generally known in the prior art.

In a further preferred embodiment, a respective switching matrix of the switching matrix arrangement interconnects with a particular group of sub-arrays in the operation of the reflector antenna. Each switching matrix is thus uniquely assigned to a corresponding group of sub-arrays for purposes of tracking a separate signal.

In a preferred embodiment, the control device used in the reflector antenna may comprise a digital beamforming means with a digital signal-processing unit. Digital beamforming is generally known from the prior art and is based on forming corresponding radiation lobe patterns by a processor in a digital domain. Corresponding converters are provided for A/D conversion of received antenna signals or for D/A conversion of antenna signals to be transmitted. The beamforming means used can, however, also comprise an analogue beamforming means with a phase shifter and/or amplifier arrangement for signal forming, controllable through an electronic control unit. In this case of beamforming the analogue antenna signals are manipulated, wherein the radiation is formed by electronic control of a phase shifter and/or amplifier arrangement.

In another preferred embodiment of the reflector antenna according to the invention, a digital beamforming means is used, which contains a number of front-end modules that can be connected via a switching matrix arrangement with the antenna elements. The front-end modules can be connected with the digital signal-processing unit. In the operation of the reflector, the front-end modules perform for the antenna elements or the digital signal-processing unit pre-processing of the signals originating from the digital signal-processing unit and/or the signals to be transmitted to the digital signal-processing unit. Such modules, also designated as front-ends, are generally known from the prior art of digital beam forming and comprise, in particular, a corresponding HF part, a ZF part, and an A/D converter.

In a preferred embodiment, the number of front-end modules used corresponds to the number of antenna elements of a sub-array for a respective group of sub-arrays, wherein by means of the respective switching matrix of a group of sub-arrays each antenna element of the activated sub-array is connected with a front-end module. This embodiment has the advantage that the number of front-end modules provided is significantly less than the number of antenna elements. In particular, an individual front-end module need no longer be provided for each antenna element, but rather it is sufficient that a front-end module is present for each antenna element of an activated sub-array of the respective group.

In a further embodiment of the reflector antenna, a digital beamforming means is used, whose digital signal-processing unit can modify the radiation lobe pattern of an activated sub-array within predetermined limits and/or can execute interference suppression by the generation of null points or reduction of side lobes. Appropriate methods for digital beamforming of this kind are known from the prior art (see, for example, J. Duggan and P. McLane, “Adaptive beamforming with a multiple beam antenna”, IEEE Int. Conf. Communications, Atlanta, Ga., USA, June 1998, Vol. 1, Pages 395-401). Thus all options for digital beamforming can also be deployed for purposes of modifying the radiation lobe pattern of the individual sub-array.

In a further embodiment of the reflector antenna, the digital beamforming means can also be configured such that the digital signal-processing unit can at least partially execute an activation and/or deactivation of sub-arrays by means of digital signal-processing. Alternatively or additionally, an activation or deactivation of the sub-arrays can also be executed purely in the digital domain, so that a corresponding switching matrix arrangement can be dispensed with, at least partially.

In a further embodiment of the reflector antenna according to the invention an analogue beamforming means is used, which contains a number of arrangements, each arrangement comprising a phase shifter and/or an amplifier and being connectable through the switching matrix arrangement with the antenna elements, wherein the phase shifter and/or the amplifier can be controlled by the electronic control unit of the analogue beamforming means. In analogy to the digital beamforming means, the number of arrangements of a phase shifter and/or an amplifier for a respective group of sub-arrays may preferably correspond to the number of antenna elements of a sub-array, wherein by means of the respective switching matrix of a group of sub-arrays, each antenna element of the activated sub-array is connected with a phase shifter and/or an amplifier. In this manner it is not necessary to provide an individual phase shifter for each antenna element, so that the number of phase shifters can be significantly reduced.

In the case in which a digital beamforming means is used, its digital signal-processing unit preferably controls the switching matrix arrangement for the activation and deactivation of the sub-arrays. Analogously, when an analogue beamforming means is used, its electronic signal-processing unit is preferably used to control the switching matrix arrangement for the activation and deactivation of the sub-arrays.

The reflector antenna according to the invention preferably works in frequency ranges that are deployed for satellite communication. In particular the reflector antenna is operated in a range from 10 to 50 GHz, e.g. in the Ku band and/or the Ka band.

By virtue of beam focusing by the reflector, the number of antenna elements of the antenna array of the reflector antenna can be significantly reduced compared with directly radiating antenna arrays. In particular, the antenna array of the reflector antenna according to the invention comprises preferably a maximum of approximately 1000, preferably a maximum of approximately 500, and particularly preferably a maximum of approximately 300 antenna elements.

In a preferred variant, a sub-array comprises a maximum of approximately 50, in particular a maximum of approximately 20, and particularly preferably approximately four (4) antenna elements. In a further embodiment of the reflector antenna according to the invention the antenna elements in the antenna array and/or the sub-array are preferably arranged in a matrix shape, wherein in particular a square is formed by the antenna array and/or the sub-array.

The reflector arrangement of the reflector antenna can be variously configured. In one embodiment the reflector arrangement has a single reflector with a central feed or an offset feed, wherein the single reflector preferably has a diameter of approximately 100 to approximately 1000 cm. Similarly the reflector arrangement can comprise an arrangement with a Cassegrain feed with main and sub-reflectors, wherein the main reflector preferably has a diameter between approximately 100 and approximately 1000 cm.

The reflector antenna according to the invention is preferably used for satellite communication. In particular, the reflector antenna is used as a GEO data relay for the transmission of signals between satellites, or between a satellite and a mobile user, or between a satellite and a ground station. The invention therefore also may preferably comprise a satellite which has one or a plurality of reflector antennae according to the invention.

### BRIEF DESCRIPTION OF THE DRAWINGS

So that the advantages of the invention will be readily understood, a more detailed description of the invention briefly described above will be provided by reference to specific embodiments that are illustrated in the appended drawings. Understanding that these drawings depict only preferred embodiments of the invention and are not considered to be limiting of its scope, the invention will be described and explained with additional specificity and detail through the use of the accompanying figures, in which:

FIG. 1 shows a schematic representation of a first embodiment of a reflector antenna according to the invention;

FIG. 2 shows a schematic representation of a second embodiment of a reflector antenna according to the invention;

FIG. 3 shows a schematic representation of a third embodiment of a reflector antenna according to the invention;

FIGS. 4A and 4B show beamforming diagrams of a parabolic reflector used in one embodiment of the invention with a radiation lobe pattern formed at the focus of the reflector, or displaced from the focus of the reflector; and

FIG. 5 shows a schematic representation of an embodiment of a control device used in the reflector antenna according to the invention.

### DETAILED DESCRIPTION

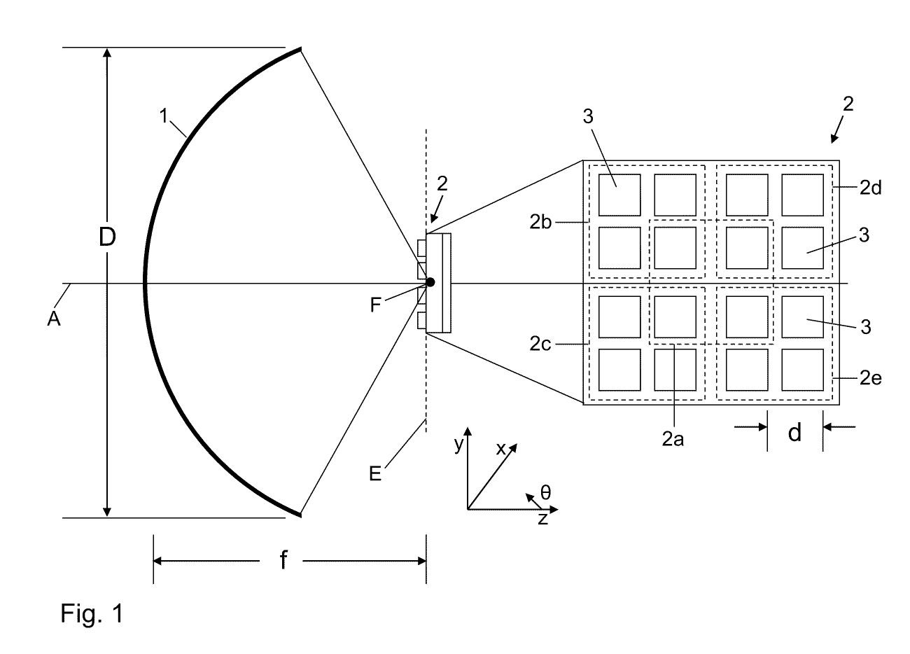

FIG. 1 shows a first embodiment of a reflector antenna according to the invention in the form of a single parabolic reflector 1 with an antenna array 2, which is arranged in the focal plane E of the reflector centrally at the focus or focal point F. FIG. 1 thus represents a single reflector with a central feed, wherein the axis of symmetry A of the single reflector runs through focal point F. The focal length of the reflector is designated in FIG. 1 by f, and the width of the reflector by D. In the embodiment of FIG. 1 the reflector antenna is operated at a frequency of 30 GHz. Diameter D of parabolic reflector 1 is sufficiently large for a high gain of approx 50 dBi to be achieved, which means that diameter D is at least approximately 111 cm. In FIG. 1 a reference coordinates system is also shown with x, y and z-directions, wherein the axis of symmetry A of the reflector runs in the z direction. Radiation should be received with the reflector at various angles of inclination to the z-axis of the coordinate system.

In the right-hand part of FIG. 1 a plan view onto antenna array 2 is reproduced in an enlarged detail representation. As can be seen, array 2 is a planar array with a plurality of individual antenna elements 3 arranged in a matrix shape. For the sake of clarity, only some of the antenna elements are provided with the reference numeral 3. Antenna elements 3 are displaced from one another by a distance d, wherein the distance d approximately corresponds to the half-wavelength of the operating frequency of the antenna and is about 0.5 cm. The representation of antenna array of FIG. 1 is exemplary and as a rule the antenna array has a larger number of antenna elements, in particular antenna arrays are used with approximately 15×15 or 16×16 antenna elements.

In the embodiment of FIG. 1. five sub-arrays 2a, 2b, 2c, 2d and 2e in the antenna array are represented in an exemplary manner, each of which comprises a sub-group of four (4) antenna elements of the array. These sub-arrays can be activated or deactivated independently of one another with a control device (not shown in FIG. 1) for purposes of the formation of radiation lobe patterns for the reception or transmission of antenna radiation. That is to say, the individual sub-arrays can be controlled with a control device such that only the signals of a corresponding active sub-array are evaluated, or signals are only supplied to corresponding active sub-arrays. The formation of the individual radiation lobe patterns of the sub-arrays takes place in a particularly preferred form of the invention using digital beamforming, as will be explained in more detail below. As one sees from FIG. 1, the sub-arrays overlap with one another, wherein sub-array 2a is arranged at the feed point of the reflector and the other sub-arrays are displaced relative to the focal point F. In particular a displacement of the feed point of the reflector in the x- and/or y-directions (i.e. a de-focusing) is achieved by the activation of the sub-arrays 2b to 2e.

The reflector antenna shown in FIG. 1 is used, for example, in a geostationary satellite as a reception antenna of a GEO data relay for receiving data from corresponding LEO satellites (Low Earth Orbiting satellites) or from ground stations. By means of suitable activation of the sub-arrays in sequence, the signal of a particular LEO satellite can be tracked. If f/D=0.5, and a maximum defocusing of 10 cm is assumed, a maximum beam deflection of 10° in one direction can be achieved. With full drive in the x and y directions a complete coverage of the movement range of a predetermined LEO satellite can be achieved. The distance d between the antenna elements defines the minimum delta angle when switching to a sub-array displaced by the distance d from the previous sub-array. With a conventional beam separation of a half-wavelength (d=0.5 cm) this delta angle is approx. 0.45° and is thus smaller than the conventional 3 dB beam width of a parabolic reflector of 0.6°.

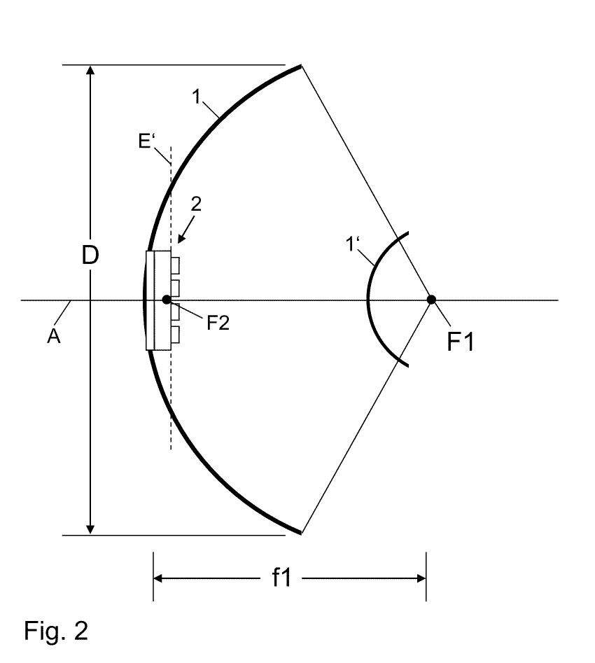

FIG. 2 shows a second embodiment of a reflector antenna according to the invention. Instead of a single reflector with a central feed, a so-called Cassegrain feed is now used. With a Cassegrain feed, a hyperbolic sub-reflector 1′ is provided in addition to a parabolic main reflector 1. As illustrated, the hyperbolic sub-reflector 1′ has two focal points F1 and F2, wherein the focal point F1 coincides with the focal point of the main reflector 1. The focal length of the main reflector 1 is denoted by f1. The antenna array 2 is arranged in the Cassegrain feed and positioned in the focal plane E′ of the focal point F2 of the sub-reflector 1′. The antenna array 2 corresponds in its structure to the antenna array of FIG. 1. The control of the antenna array by means of a control device is also the same as in FIG. 1. The embodiment of FIG. 2 provides a modified reflector arrangement.

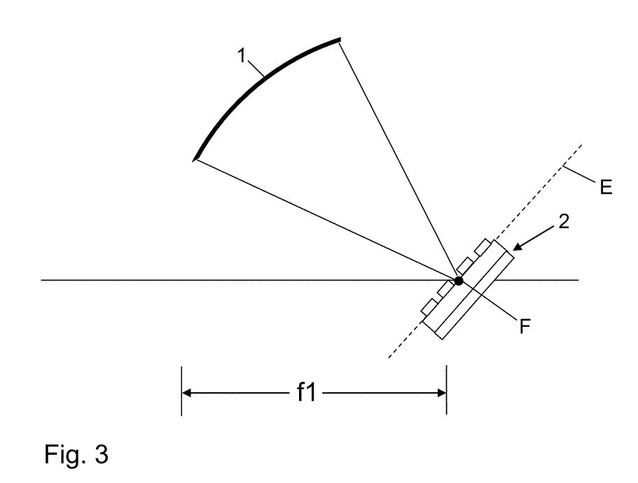

FIG. 3 shows a third embodiment of a reflector antenna according to the invention. This embodiment differs from the embodiment of FIG. 1 only with respect to the feature that instead of a central feed an offset feed is used for the antenna array 2. As a result of the offset feed, any shadowing of the parabolic reflector 1 by the antenna array is avoided. In accordance with FIG. 1 the antenna array 2 is arranged in the focal plane E at the focal point F of the parabolic reflector 1.

As stated above, in a preferred embodiment of the invention, the radiation lobe patterns are formed by means of digital beamforming. The beamforming takes place by means of digital weighting of phase and amplitude, the beam direction of a radiation lobe pattern to be modified within a small angle range, so that the individual activated sub-arrays of an antenna array enable continuous tracking of a corresponding transmitter. Moreover, by modification of phase and amplitude allocations, further digital beamforming properties can be used, such as the generation of null points for purposes of interference suppression.

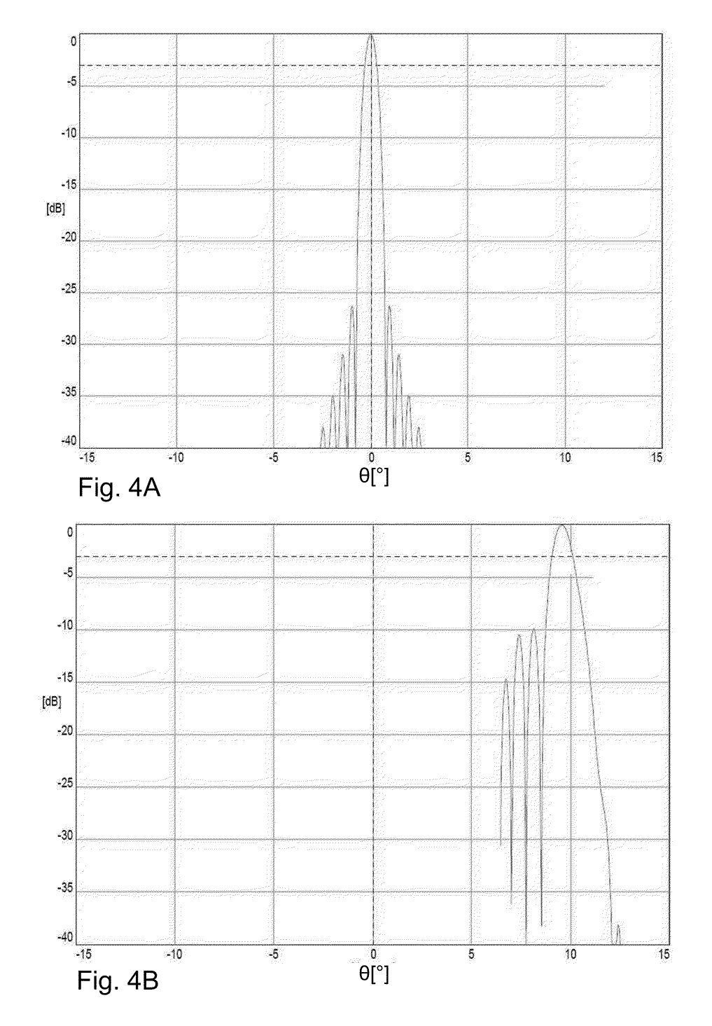

FIGS. 4A and 4B show examples of radiation diagrams that can be generated with digital beamforming by means of a reflector arrangement according to the principle of FIG. 1. FIG. 4A shows the radiation lobe pattern in the case of a sub-array activated at the focus of the reflector. One sees that sharp null points are generated, with which corresponding interferers can be disabled. FIG. 4B shows a corresponding radiation lobe pattern in a case where the reflector is defocused, i.e. when an active sub-array is displaced relative to the focal point of the reflector. One sees that the radiation lobe pattern generated always ensures sufficiently good interference suppression.

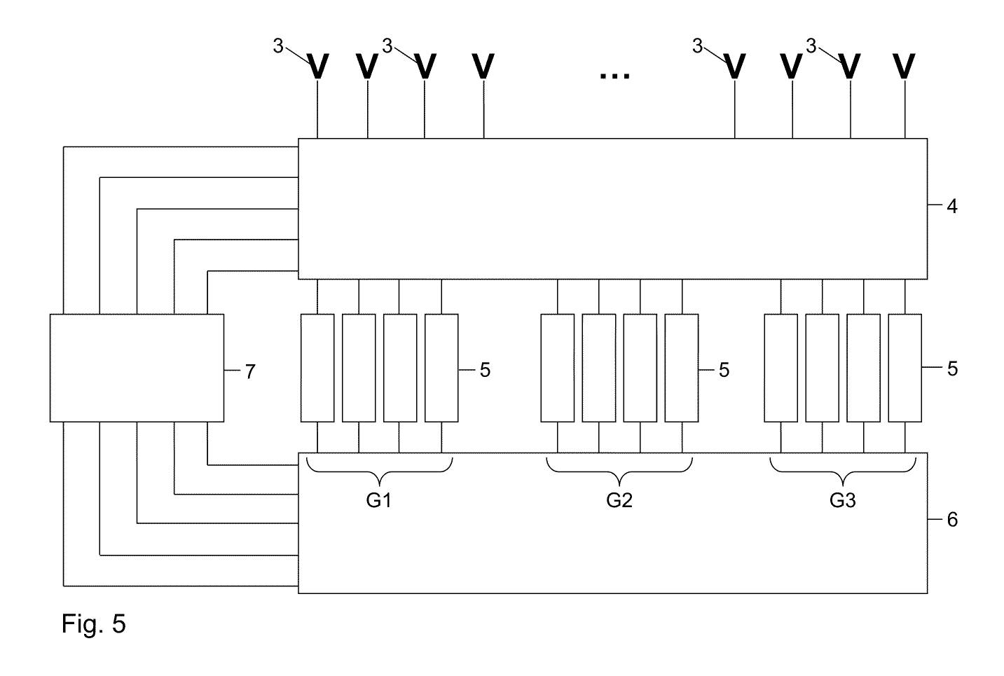

FIG. 5 shows a preferred embodiment of a control device, with which the antenna elements of a corresponding antenna array can be activated or deactivated, and which is based on digital beamforming. The individual antenna elements of the antenna array are schematically reproduced, wherein only some of the antenna elements are denoted with the corresponding reference numeral 3 for the sake of clarity.

The activation or deactivation of the antenna elements takes place with a switching matrix arrangement 4. Switching matrix 4, for example, may be a MEMS component, with which the antenna elements 3 are controlled such that three groups of sub-arrays are formed. Each such sub-array may comprise four antenna elements. By means of the activation or deactivation of sub-arrays of the respective group, the signal of a satellite can be tracked individually. To this end, the switching matrix arrangement 4 is structured in the form of three switching matrices (not visible in FIG. 5), which independently of one another activate the sub-arrays of the particular group. According to FIG. 5, the activation of a sub-array takes place in that, via the respective switching matrix or switching matrix module, the respective antenna elements of the sub-array to be activated are interconnected with front-end modules or front-ends 5. As illustrated in FIG. 5, only some of the front-ends are designated with reference symbol 5 for the sake of clarity. Front-ends 5 are located upstream of a digital processor module or digital processor 6, which executes the digital beamforming function. Front-ends 5 comprise an HF part, a ZF part, together with an appropriate A/D converter, which digitizes the analogue antenna signals for digital beamforming by means of digital processor 6. Such front-ends 5 are well known from the prior art and comprise, in particular, corresponding amplifiers, filters and mixers, in addition to an A/D converter.

In the embodiment of FIG. 5, twelve front-ends 5 are provided in total in three groups G1 to G3, each with four front-ends. Each front-end is interconnected with an antenna element of a sub-array, and the front-ends of each group are connected with another switching matrix of the switching matrix arrangement 4. Accordingly, each group of front-ends is assigned to a group of sub-arrays for the purposes of tracking a separate satellite signal. As will be appreciated, various numbers of groups of sub-arrays and front-ends, together with another corresponding number of switching matrices and modules, can also be provided, to track the signals of various numbers of satellites in this manner. Similarly, a sub-array can comprise more or less than four (4) antenna elements, as a result of which the number of front-ends in a group may also be modified.

The use of the switching matrix arrangement according to FIG. 5 has the advantage that it is not necessary for a separate front-end to be provided for each individual antenna element. The number of front-ends used must simply correspond to the number of antenna elements of the sub-array for each signal to be tracked. In this manner a particularly simple implementation of control of the antenna elements is achieved. In the embodiment of FIG. 5, the interconnection of the antenna elements with the front-ends by means of the switching matrix arrangement is controlled by a digital processor module 6. To this end digital processor 6 is in communication with the switching matrix arrangement through an interface module 7. Thus, in addition to the task of the digital beamforming, digital processor 6 also undertakes the control of the activation or deactivation of the antenna elements. The digital signal processing by digital processor 6 can take place in parallel with the respective four signal branches of the front-end groups G1 to G3.

For implementation of a GEO data relay in a geostationary satellite for purposes of tracking 10 LEO satellites, an antenna array with 300 antenna elements can be used, for example, in one variant of the invention. Based on the preferred embodiment of FIG. 5, using sub-arrays or sub-array modules with four antenna elements, only 40 front-ends are required instead of 300.

The embodiments of a reflector antenna according to the invention as previously described have a series of advantages. By the suitable activation of sub-arrays, flexible radiation lobe patterns can be generated in different spatial directions, wherein, by the combination of the antenna array with a reflector arrangement, a correspondingly high gain can also be achieved. By using digital beamforming, systematic control of sub-arrays based on a corresponding switching matrix can be achieved, thereby allowing the number of front-ends to be significantly reduced. Moreover, additional advantages of digital beamforming include exact directionality of the radiation lobe pattern which is enabled by means of additional phase and amplitude variation. Furthermore, digital beamforming allows implementation of additional methods for the reduction of side lobes and null point generation to suppress interference signals.

Many of the functional units described in this specification have been described or labeled as modules, in order to more particularly emphasize their implementation independence. For example, a module may be implemented as a hardware circuit comprising custom circuits, very large scale integration (VLSI) circuits, ultra large scale integration (ULSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of instructions, including computer instructions, that may, as an example, be organized as an object, procedure, or function. Nevertheless, the executables of an identified module need not be physically located together, but may comprise disparate instructions stored in different locations which, when joined logically, comprise the element or module and achieve the stated purpose for the element or module.

A module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “a preferred embodiment,” “one embodiment,” “an embodiment,” or similar language means that a particular feature, structure, or characteristic described in connection with the embodiment is included in at least one embodiment of the present invention. Thus, appearances of the phrases “in a preferred embodiment,” “in one embodiment,” “in an embodiment,” and similar language throughout this specification may, but do not necessarily, all refer to the same embodiment.

Any instructions or data identified herein may reside, for example, in RAM, ROM or other storage media of a computer. Alternatively, such instructions or data may be contained on a data storage medium, such as a computer CD, DVD, ROM, RAM or diskette. Furthermore, the instructions may be stored on a DASD array, magnetic tape, conventional hard disk drive, electronic read-only memory, flash memory, optical storage device, or other appropriate data storage device. In such an alternate embodiment, computer-executable instructions may be lines of compiled executable code as available in any computer executable code, steps or language.

The apparatus, control devices, beamforming means and computer code elements of the present invention may be controlled or performed by a computer program. The computer program can exist in a variety of forms both active and inactive. For example, the computer program can exist as software possessing program instructions or statements in source code, object code, executable code or other formats; firmware program(s); or hardware description language (HDL) files. Any of the above can be embodied on a computer readable medium, which include storage devices and signals, in compressed or uncompressed form. Such computer readable storage devices include conventional computer RAM (random access memory), ROM (read only memory), EPROM (erasable, programmable ROM), EEPROM (electrically erasable, programmable ROM), and magnetic or optical disks or tapes. Computer readable signals, whether modulated using a carrier or not, can include heartbeat data packages, error data packages, test data packages and the like. It will be understood by those skilled in the art that a computer system hosting or running the apparatus, control devices, beamforming means or computer code elements of the present invention can be configured to access a variety of signals, including but not limited to signals downloaded through the Internet or other networks. Such may include distribution of executable software program(s) over a network, distribution of computer programs on a CD ROM or via Internet download and the like.

While the present invention has been described above in terms of specific embodiments, it is to be understood that the invention is not intended to be confined or limited to the preferred embodiments disclosed herein and that the scope of the present invention fully encompasses other embodiments which may become obvious to those skilled in the art. In addition, while specific component values, focal lengths and the like have been shown for ease of illustration and description, it should be understood that a variety of combination of values and lengths is possible and contemplated by the present invention. Further, while specific connections have been used and shown for ease of description, it should also be understood that a variety of connection points are possible and may vary depending on the specifics of the application and circuit used. These and all other such modifications and changes are considered to be within the scope of the appended claims.

What is claimed is:

1. A reflector antenna, in particular for the reception and/or transmission of signals from and/or to satellites, comprising:
a reflector arrangement for focusing antenna radiation in a focal plane;
an antenna array arranged in at least one of the focal plane and in the vicinity of the focal plane, with a plurality of antenna elements;
a control device with a beamforming means; and
sub-arrays comprising at least one antenna element of the antenna array wherein, through the control device, sub-arrays can be activated and deactivated for at least one of reception and transmission of antenna radiation, and wherein during the operation of the reflector antenna for a respective activated sub-array, a radiation lobe pattern is formed by the beamforming means for at least one of reception and transmission of antenna radiation.

2. The reflector antenna of claim 1 characterized in that at one point in time an individual sub-array or a plurality of sub-arrays can be activated by the control device simultaneously.

3. The reflector antenna of claim 1 characterized in that the sub-arrays overlap with one another.

4. The reflector antenna of claim 1 characterized in that the sub-arrays are disjoint.

5. The reflector antenna of claim 1 characterized in that one or a plurality of groups of sub-arrays is provided, wherein, in the operation of the reflector antenna, each group is controlled through the control device by activation and deactivation of the sub-arrays of the group to track a separate signal, wherein a respective separate signal is in particular a signal from or to an object moving relative to the reflector antenna.

6. The reflector antenna of claim 5 characterized in that the object moving relative to the reflector antenna is a satellite.

7. The reflector antenna of claim 1 characterized in that the control device comprises a switching matrix arrangement with a switching matrix, by which arrangement the antenna elements of the respective sub-arrays can be interconnected with the beamforming means for the activation and deactivation of the respective sub-arrays.

8. The reflector antenna of claim 1 characterized in that the control device comprises a switching matrix arrangement with a plurality of switching matrices, by which arrangement the antenna elements of the respective sub-arrays can be interconnected with the beamforming means for the activation and deactivation of the respective sub-arrays.

9. The reflector antenna of claim 7 characterized in that the switching matrix arrangement is a MEMS component.

10. The reflector antenna of claim 5 characterized in that the control device comprises a switching matrix arrangement with one or a plurality of switching matrices, by which arrangement the antenna elements of the respective sub-arrays can be interconnected with the beamforming means for the activation and deactivation of the respective sub-arrays, and in the operation of the reflector antenna, a respective switching matrix of the switching matrix arrangement interconnects with a particular group of sub-arrays.

11. The reflector antenna of claim 1 characterized in that the control device comprises a digital beamforming means with a digital signal-processing unit for purposes of beamforming or an analogue beamforming means with an arrangement of phase shifters and/or amplifiers controlled by an electronic control unit for purposes of signal shaping.

12. The reflector antenna of claim 11 characterized in that the control device comprises a digital beamforming means, to which a number of front-end modules is assigned, the front-end modules being connectable with the antenna elements through a switching matrix arrangement, wherein the front-end modules are connected with the digital signal-processing unit, and wherein the front-end modules in the operation of the reflector antenna pre-process the signals originating from at least one of the digital signal-processing unit, the antenna elements, and the digital signal-processing unit, to be transmitted to the digital signal-processing unit.

13. The reflector antenna of claim 12 characterized in that a number of front-end modules corresponding to the number of antenna elements of a sub-array is provided for a respective group of sub-arrays, wherein by means of the respective switching matrix of a group of sub-arrays each antenna element of the activated sub-array is connected with a front-end module.

14. The reflector antenna of claim 13 characterized in that the control device comprises a digital beamforming means whose digital signal-processing unit can modify the radiation lobe pattern of an activated sub-array within predetermined limits or can execute interference suppression by the generation of null points or reduction of side lobes.

15. The reflector antenna of claim 14 characterized in that the control device comprises a digital beamforming means, whose digital signal-processing unit can execute at least partially an activation and/or deactivation of sub-arrays by means of digital signal-processing.

16. The reflector antenna of claim 15 characterized in that the control device comprises an analogue beamforming means, to which a number of arrangements is assigned, each arrangement comprising a phase shifter or an amplifier and being connectable through the switching matrix arrangement with the antenna elements, wherein the arrangements can be controlled by the electronic control unit.

17. The reflector antenna of claim 16 characterized in that a number of arrangements of a phase shifter or an amplifier is provided for a respective group of sub-arrays which number corresponds to the number of antenna elements of a sub-array, wherein by means of the respective switching matrix of a group of sub-arrays, each antenna element of the activated sub-array is connected with a phase shifter arrangement.

18. The reflector antenna of claim 17 characterized in that the digital signal-processing unit or the electronic control unit in the operation of the reflector antenna controls the switching matrix arrangement for the activation and deactivation of the sub-arrays.

19. The reflector antenna of claim 1 characterized in that radiation in the range from 10 to 50 GHz, in particular in the Ku and/or Ka band, can be received and/or transmitted by the reflector antenna.

20. The reflector antenna of claim 1 characterized in that the antenna array comprises a maximum of approximately 1000 antenna elements.

21. The reflector antenna of claim 1 in which a sub-array comprises a maximum of approximately 50 antenna elements.

22. The reflector antenna of claim 1 characterized in that the antenna elements in the antenna array or the sub-array are arranged in a matrix shape, wherein a square is formed by the antenna array or the sub-array.

23. The reflector antenna of claim 1 characterized in that the reflector arrangement comprises a single reflector with a central feed or an offset feed, wherein the single reflector preferably has a diameter between approximately 100 cm and approximately 1000 cm.

24. The reflector antenna of claim 1 characterized in that the reflector arrangement comprises an arrangement with a Cassegrain feed with main and sub-reflectors, wherein the main reflector preferably has a diameter between approximately 100 cm and approximately 1000 cm.

25. A satellite having a reflector antenna for the reception or transmission of signals comprising:
a reflector arrangement for focusing antenna radiation in a focal plane;
an antenna array arranged proximately to the focal plane with a plurality of antenna elements;
a control device with beamforming means, wherein by means of the control device, sub-arrays including an antenna element of the antenna array can be activated and deactivated for the reception and/or transmission of antenna radiation, and wherein during operation of the reflector antenna for a respective activated sub-array, a radiation lobe pattern is formed by the beamforming means for the reception and/or transmission of antenna radiation.

26. The satellite of claim 25 wherein the satellite is a GEO-satellite.

27. The satellite of claim 25 wherein the satellite is a GEO-satellite including a plurality of reflector antennae.

28. The satellite of claim 25 wherein at one point in time at least one of an individual sub-array can be activated through the control device.

29. The satellite of claim 25 wherein at one point in time a plurality of sub-arrays can be activated simultaneously through the control device.
